(19) United States
(12) Patent Application Publication
(10) Pub. No.: US 2006/0172250 A1
(43) Pub. Date: Aug. 3, 2006

(54) Inelligent tracking of dental devices

(76) Inventor: Huafeng Wen, Redwood City, CA (US)

Correspondence Address: MORRISON & FOERSTER LLP, 755 PAGE MILL RD, PALO ALTO, CA, 94304-1018, US

(21) Appl. No.: 11/050,050

(22) Filed: Feb. 3, 2005

(51) Int. Cl. A61C 8/00; A61C 3/00

(52) U.S. Cl. 433/18; 433/173

(57) ABSTRACT

A system for tracking a dental device includes a label storing a data structure comprising information about a patient's dental treatment, wherein the label is configured to be attached to the dental device and a detector configured to extract data from the data structure stored in the label to determine the shipping destination of the dental device.

### CROSS-REFERENCES TO RELATED INVENTIONS

The present invention is also related to commonly assigned U.S. patent application, titled “Methods for producing non-interfering tooth models” by Huafeng Wen and concurrently filed and commonly assigned U.S. patent application, titled “Storage system for dental devices” by Huafeng Wen and concurrently filed.

The present invention is also related to commonly assigned U.S. patent application Ser. No. 11/013,152, titled “A base for physical dental arch model” by Huafeng Wen, filed Dec. 14, 2004, commonly assigned U.S. patent application Ser. No. 11/012,924, titled “Accurately producing a base for physical dental arch model” by Huafeng Wen, filed Dec. 14, 2004, commonly assigned U.S. patent application Ser. No. 11/013,145, titled “Fabricating a base compatible with physical dental tooth models” by Huafeng Wen, filed Dec. 14, 2004, commonly assigned U.S. patent application Ser. No. 11/013,156, titled “Producing non-interfering tooth models on a base” by Huafeng Wen, filed Dec. 14, 2004, commonly assigned U.S. patent application Ser. No. 11/11/013,160, titled “System and methods for casting physical tooth model” by Huafeng Wen, filed Dec. 14, 2004, commonly assigned U.S. patent application Ser. No. 11/013,159, titled “Producing a base for accurately receiving dental tooth models” by Huafeng Wen, and filed Dec. 14, 2004, commonly assigned U.S. patent application Ser. No. 11/11/013,157, titled “Producing accurate base for dental arch model” by Huafeng Wen, filed Dec. 14, 2004.

The present invention is also related to commonly assigned U.S. patent application Ser. No. 10/979,823, titled “Method and apparatus for manufacturing and constructing a physical dental arch model” by Huafeng Wen, filed Nov. 2, 2004, U.S. patent application Ser. No. 10/979,497, titled “Method and apparatus for manufacturing and constructing a dental aligner” by Huafeng Wen, filed Nov. 2, 2004, U.S. patent application Ser. No. 10/979,504, titled “Producing an adjustable physical dental arch model” by Huafeng Wen, filed Nov. 2, 2004, and U.S. patent application Ser. No. 10/979,824, titled “Producing a base for physical dental arch model” by Huafeng Wen, filed Nov. 2, 2004. The disclosure of these related applications are incorporated herein by reference.

### TECHNICAL FIELD

This application generally relates to the field of dental care, and more particularly to a system and a method for storing dental devices.

### BACKGROUND

Orthodontics is the practice of manipulating a patient's teeth to provide better function and appearance. In general, brackets are bonded to a patient's teeth and coupled together with an arched wire. The combination of the brackets and wire provide a force on the teeth causing them to move. Once the teeth have moved to a desired location and are held in a place for a certain period of time, the body adapts bone and tissue to maintain the teeth in the desired location. To further assist in retaining the teeth in the desired location, a patient may be fitted with a retainer.

To achieve tooth movement, orthodontists utilize their expertise to first determine a three-dimensional mental image of the patient's physical orthodontic structure and a three-dimensional mental image of a desired physical orthodontic structure for the patient, which may be assisted through the use of x-rays and/or models. Based on these mental images, the orthodontist further relies on his/her expertise to place the brackets and/or bands on the teeth and to manually bend (i.e., shape) wire, such that a force is asserted on the teeth to reposition the teeth into the desired physical orthodontic structure. As the teeth move towards the desired location, the orthodontist makes continual judgments as to the progress of the treatment, the next step in the treatment (e.g., new bend in the wire, reposition or replace brackets, is head gear required, etc.), and the success of the previous step.

A variety of designs exist in dental brackets and dental aligners. An orthodontic treatment usually includes a plurality of treatment steps, each of which requires the use of a different aligner or bracket so that the patient's teeth can be moved incrementally to the desired positions. There is a long felt need in the dental care industry to properly track dental devices such as aligners and brackets for the manufacturer, the doctors, the patients, and jobs for different steps of the orthodontic treatments.

### SUMMARY OF THE INVENTION

The present invention has been devised to provide a practical, effective and efficient methods and apparatus to manufacture and construct the physical dental arch model.

In one aspect, the present invention relates to a system for tracking a dental device, comprising:

a label storing a data structure comprising information about a patient's dental treatment, wherein the label is configured to be attached to the dental device; and

a detector configured to extract data from the data structure stored in the label to determine the shipping destination of the dental device.

In another aspect, the present invention relates to a method for tracking dental devices, comprising:

setting up data structure comprising information about a patient's dental treatment;

storing the data structure in a label;

attaching the label to a dental device; and

extracting data from the data structure stored in the label to determine the shipping destination of the dental device.

Embodiments may include one or more of the following advantages. The dental devices are tracked by intelligent labels such as bar codes and RFID devices.

A dispensing system is provided for storing dental devices such a dental aligners. The dental devices are securely stored in a container body to protect them from damage. The dispensing system is convenient, compact and portable. The dispensing system can maintain a fixed FIFO order of the stored dental devices. The dispensing system can automatically release the dental devices by simply pushing a release button. The dispensing system can serve as a useful tool in orthodontic treatment.

The details of one or more embodiments are set forth in the accompanying drawing and in the description below. Other features, objects, and advantages of the invention will become apparent from the description and drawings, and from the claims.

### BRIEF DESCRIPTION OF THE DRAWINGS

The accompanying drawing, which are incorporated in and form a part of this specification, illustrate embodiments of the invention and, together with the description, serve to explain the principles of the invention:

FIG. 1 is a dispensing container for dental devices in accordance with the present invention.

FIG. 2 illustrates the locking mechanism of the container cap at the upper end of the container body.

FIG. 3 illustrates a spring load mechanism on the underside of the container cap.

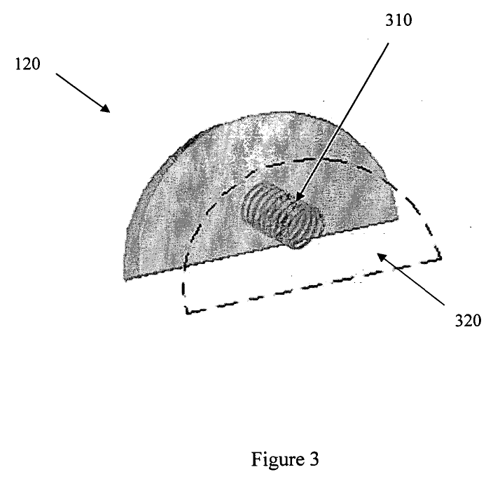

FIG. 4 shows a door for the dispensing window in the front near the lower end of the dispensing container.

FIG. 5 illustrate an dispensing mechanism for dispensing dental devices from the dispensing container.

FIG. 6 illustrates a slide-able back for the dispensing container.

FIG. 7 illustrates examples of smart labels applicable to tracking dental devices.

FIG. 8 illustrates an exemplified data structure that can be stored in the smart labels for tracking dental devices.

### DESCRIPTION OF INVENTION

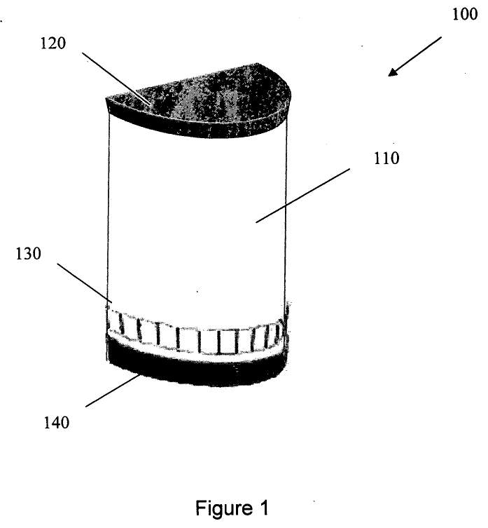

As shown in FIG. 1, a dispensing container 100 for dental devices includes a container body 110, a container cap 120 that can seal the upper end of the container body 110, a dispensing window 130 in the lower front side, and a release button 140. The dispensing container 100 can store dental devices such as dental aligners, dental brackets, dental arch models, tooth models, and bases or base components for tooth models. The dental devices can stack up on each other inside the container body 110. The dental devices can pop out of the dispensing window 130 by pushing the release button 140. The dental devices are stored in the order they were stored, that is, “First In, First Out” (FIFO). The container body 110 can be cylindrically shaped and made of a waterproof material that can withstand rough handling such that the dental devices stored in the container will not be damaged if the container is accidentally dropped on to the floor.

Details of the fabrication of the dental aligners, dental arch models, dental tooth models, and bases for tooth models are disclosed in commonly assigned and above referenced U.S. patent application Ser. No. 10/979,823, titled “Method and apparatus for manufacturing and constructing a physical dental arch model” by Huafeng Wen, filed Nov. 2, 2004, U.S. patent application Ser. No. 10/979,497, titled “Method and apparatus for manufacturing and constructing a dental aligner” by Huafeng Wen, filed Nov. 2, 2004, U.S. patent application Ser. No. 10/979,504, titled “Producing an adjustable physical dental arch model” by Huafeng Wen, filed Nov. 2, 2004, and U.S. patent application Ser. No. 10/979,824, titled “Producing a base for physical dental arch model” by Huafeng Wen, filed Nov. 2, 2004, the content of which is incorporated herein by reference.

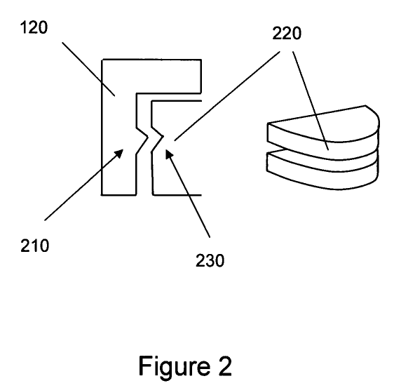

The container cap 120, as shown in FIG. 2, is constructed so that it can snap to be closed. The upper end 220 of the dispensing container 100 includes a groove 230 around its rim. The inner face of the container cap 120 includes a protrusion 210 that fits the groove 230. When the container cap 120 is pressed down in the upper end 220 of the dispensing body 110, the protrusion 210 snaps into the groove 230 to lock the container cap 120 to the container body 110.

The container cap 120 includes a tensile spring 310 fixed to its underside. A pressure plate 320 is connected to the end of the spring 310. The spring loaded pressure plate 320 pushes the dental devices stored in the container body 110 downward to ensure the dental devices to be tightly packed inside the container body 110. The spring load also enables the dental device at the bottom to be always registered to the dispensing window 130. When uncompressed, the spring 310 can reach the bottom of the container body 110 such that the last dental device in the container body 110 can be dispensed through the dispensing window 130.

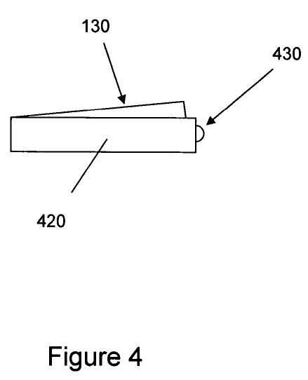

The dispensing window 130 can be closed by a door 420 as shown in FIG. 4. The door 420 can be locked by a latch 430 fixed on the door 420 to prevent dental devices from falling out of the container body 110. Alternatively, the door 420 can also be kept closed by a spring mechanism that automatically closes the dispensing window 130 after each extraction of a dental device.

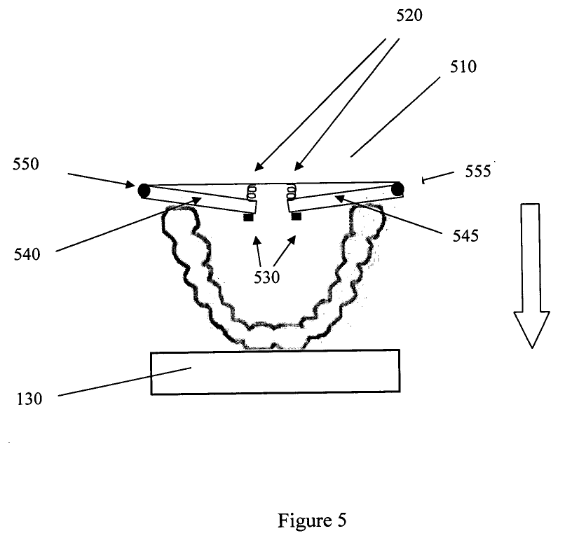

The dispensing container 100 includes a dispensing mechanism. As shown in FIG. 1 and FIG. 5, the automatic dispensing mechanism includes a release button 140 located right below the dispensing window 130. The release button 140 is attached to a spring. Two more springs 520 are attached to the back wall of the container body 110. The ends of the springs 520 are attached to stoppers 530 and pushing sticks 540, 545 that are hinged at hinges 550, 555.

When the release button 140 is pressed, the spring attached to it is compressed, the stoppers 530 move forwards causing the pushing sticks 540, 545 to move forward. This forward motion moves the bottom most dental device in the container body 100 to partially move out of the dispensing window 130. As soon as the partially popped out dental device is removed, the springs 520 retract, moving the push sticks 540, 545 to the initial positions. The dental devices above are pushed downwards by the spring 310 on the container cap 120. The spring attached to the release button 140 returns to its normal position, pushing the release button 140 outwards. This motion causes the stoppers to return to their respective positions as well. The dispensing container 100 is now ready to dispense another dental device. The described arrangement allows only one dental device such as an aligner to be dispensed at a time.

In one embodiment, a packaging station is included at the bottom of the dispensing container 100. The dispensed dental device is packaged in a packaging material before it is removed from the container 100.

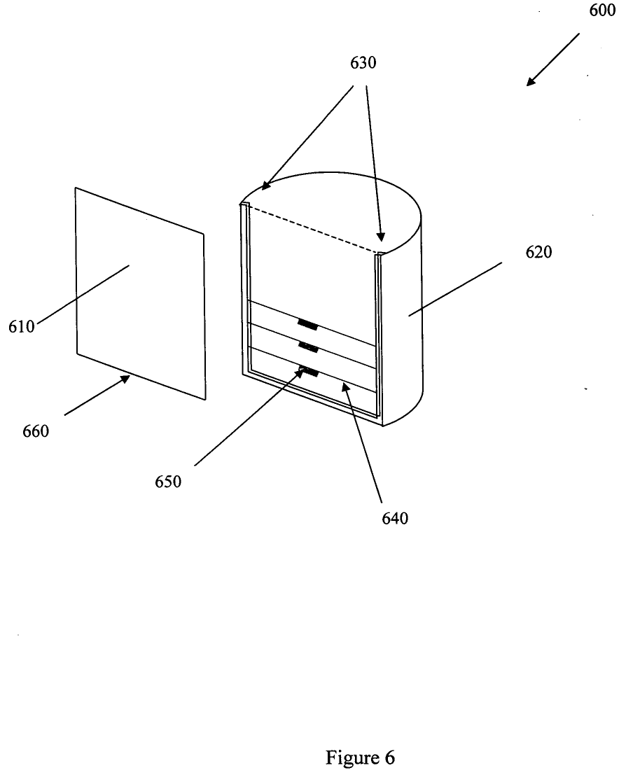

In another embodiment, the dispensing container 600 includes a slide-able door 610 on the back of the container 620, as shown in FIG. 6. The slide-able door 610 can slide into slots 630 on the container body 620. The dental devices 640 are packed in a stack in FIFO order. The dental devices 640 can be tagged by tags 650 that can be barcodes or RFID devices. The tags 650 are facing backward such that they can be read or scanned once the slide-able door 610 slides open. The tags can also be replaced or changed if the plans for the dental devices are changed.

In another embodiment, the lower edge 660 of the slide-able door 610 has a sharp edge that can be is used to cut off packaging material of the dental devices. The cut-open packages containing the dental devices can be dispensed and conveniently taken out of the package by a user.

In accordance to another embodiment of the present invention, the dental devices for patients can be accurately labeled and tracked by the manufacturer of the dental devices and in the doctors' offices so that the dental devices can be correctly used for the right patients.

In one example, the dental device can be a dental aligner. The orthodontic treatment plan for a patient typically requires the fabrications of a sequence of aligners that will be worn by the patient sequentially over a period of time. The number of aligners generated depends on the complexity of the treatment: the more complex the case, the more steps it will take to treat the patient's teeth and hence the more aligners required for this treatment. Each set of aligner will move the teeth gradually in the direction desired by the treatment plan.

The design and the use of the aligners involve a plurality of steps and the handling of several entities. The treatment plan is designed by a company in accordance to the requirements of a dentist. The aligners fabricated according to the designs by a manufacturer that is often located outside of the U.S. The aligners fabricated are then shipped to an operator in the U.S. The U.S. operator then ships the aligners to the dentist or the patient. The dentist or the patient needs to properly use the aligners at different steps of the orthodontic treatment.

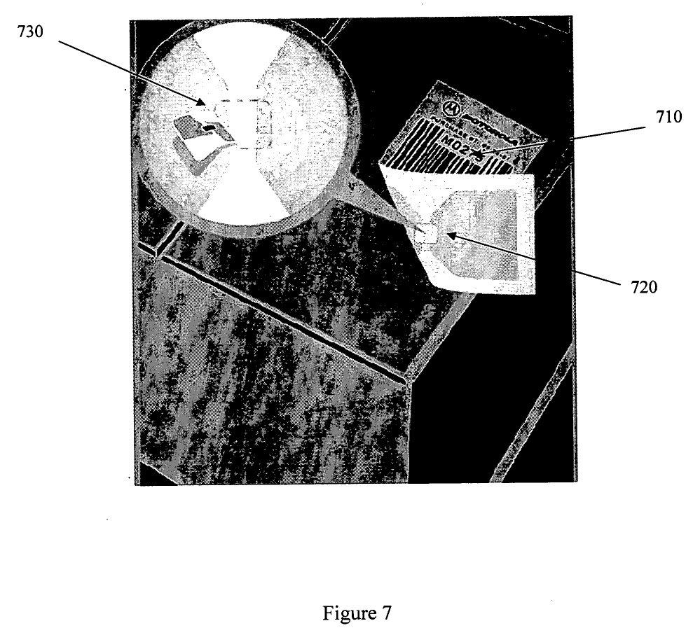

Dental aligners have to be properly tracked and managed due the number of the aligners and the large number of parties and locations involved for each treatment. In accordance with the present invention, the dental devices 700 can be tracked by smart labels such as bar codes 710, and RFID tags 720, 730, as shown in FIG. 7.

The dental devices can be tracked by Universal Product Code (UPC) bar codes. A (UPC) bar code is assigned to a treatment once it is created, which uniquely identifies that treatment. As the case moves through the company, the bar code is used to keep track of where the case is at any given time. If an operator needs to assign a case to himself, he first scans the case bar code and then his own personal bar code. This process assigns the case to that person. This bar code is used to keep track of where a case is at any given time within the company. If a manager wishes to find out where the case is, they need to log in to our ERP application and enter the Job ID and they will be told what status the case is in at that time and which departments it has gone through before.

After a case has been treated by the Ortho Treat department, it is first verified by an orthodontist. The manufacture of their aligners in the Aligner Fabrication department. After the aligners have been manufactured and disinfected, they are packaged and sorted according to their shipment date in the shipment department. A bar code is attached to each aligner of each stage of a treatment so we can track the movement of each aligner. The bar code contains information about the job that aligner belongs to and uniquely identifies its stage number. The patient can log onto a web site before each shipment of aligners to verify the accuracy of the aligners. The batch of aligners are shipped once the approval of the patient is received. Each particular set of aligners is shipped as scheduled. The shipment is confirmed by scanning the bar code before delivered to the US Post Office. The shipment confirmation can is updated on the database and viewable by the patient or the dentist. A report can also be generated for review by other authorized personnel. The report can include for example the number of jobs shipped by the shipment department during a period time.

Once the aligner's batch box from the manufacturer is received by the US operator, the operator scans the bar code of each aligner out of the box. This box contains both the doctor boxes which contain the first aligners and the patient aligners which need to be shipped to each individual patient. The first aligners will be shipped to the doctors who will then proceed with shipping the first aligners to the patient. The rest of the patient aligners will be dispatched to each individual patient from our US office.

This bar code scanning results in the generation of events in the database which indicate that all the aligners of this batch shipment have been received in the US office. Now if a manager in Pakistan wants to know if a particular aligner made it to the US office, he/she will run a report on our online ERP software and will be notified of where that particular aligner is.

Once a batch of aligners is requested to be shipped to the doctor, the US operator assembles all the aligners for the particular doctor in a package and ship the package to the doctor using a shipment company such as FedEx or UPS. A tracking number will be assigned by the shipping company which will be stored on the database in association with the UPC barcode for the case. The shipping tracking number can be assessed by the doctor on a website. The shipment of aligners can be similarly dispatched to an individual patient.

The dental devices such aligner can also be tracked by other smart labels such as radio frequency identification (RFID) tags. RFID tags are minute programmable read and write labels. Common types of RFID tags include inductively coupled RFID Tags and capacitively coupled RFID Tags. An inductively coupled RFID tag includes three main components: a microprocessor that can be in varying sizes, a metal coil, and an encapsulation that wraps around the chip and coil. The encapsulation is typically made of glass or polymer materials. The metal coil normally includes copper or aluminum wires that are wound around a transponder. The metal coil serves as the tag's antenna. The tag transmits signals to the reader, with read distance determined by the size of the coil antenna. These coil antennas can operate at 13.56 MHz.

Inductive RFID tags are inductively powered by the magnetic field generated by the reader. The tag's antenna picks up the magnetic energy. The tag communicates with the reader. The tag modulates the magnetic field to retrieve data from the reader and transmit data back to the reader.

The capacitively coupled RFID tags do not comprise the metal coil and use a small amount of silicon comparing to the inductively coupled RFID tags. A capacitively coupled tag includes three main components: a microprocessor, conductive ink, and a paper substrate. The microprocessor can be for example a silicon chip 3 mm² that can store 96 bits of data which allows the storage of trillions of unique product numbers. The conductive ink can be a carbon-based ink that is printed in an image pattern on the paper substrate. The patterned conductive ink acts as the antenna for the capacitively coupled RFID tag.

The capacitively coupled RFID tags more flexible and of lower costs than the inductively coupled RFID tags. The capacitively coupled tags can currently be as low as 50 cents, which is expected to trend lower in the future. The capacitively coupled RFID tags are powered by electric fields generated by the reader rather than magnetic energy as in the case of inductively coupled RFID tags. The diction range is more limited that inductive counterpart.

The use of RFID tags allow the dental devices to be read while stacked up, which is more convenient and provides higher throughput than barcode scanners. The RFID tags can also be recycled by removing from the used dental devices and reprogramming for a new batch of dental devices. The multiple uses also lower the effective costs of the RFID tags.

In another embodiment, the label can be embedded inside the dental devices or inside a package containing the dental devices. The labels do not have to be visible from outside of the dental device or the package. For example, the components of a tooth model, different tooth models of a physical dental arch model, a base or different base components can all be labeled by embedded labels so that they can be always properly tracked.

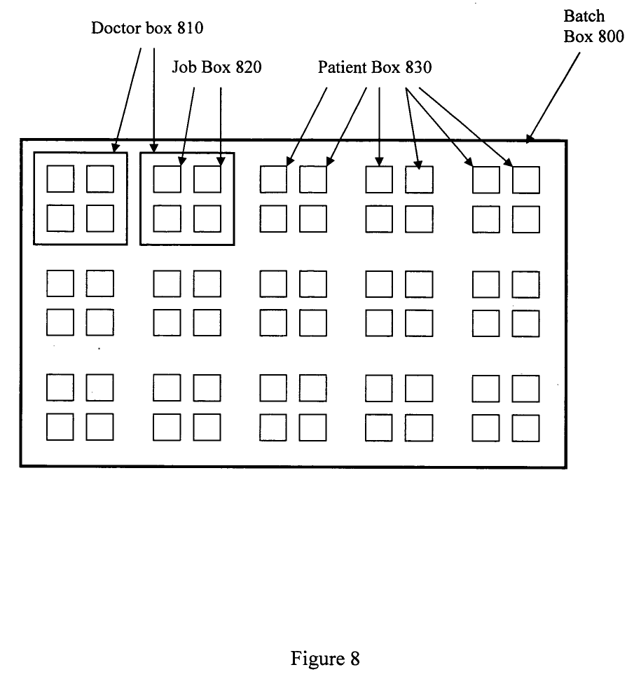

The complexity of the design, manufacture, distribution, and use of the dental devices require proper design of data structure stored in the barcode, and RFID tags. In one embodiment, a data structure is illustrated in FIG. 8. The data structure includes a batch box 800 that can comprise doctor box 810, job box 820, and patient box 830. The dental devices such as aligners are typically shipped from the manufacturer to the US operator in a bulk package that includes batches aligners for a plurality of patients. Each package for a patient or a doctor can include multiple boxes containing different dental devices such as aligners, tooth models, base or base components for a dental arch model for that particular patient.

The first-stage aligners are typically shipped to a doctor and the rest of batches directly shipped to the patient. The batches shipped from the manufacturer to the doctor therefore typically contain aligners for different patients each associated with different shipment date. The doctor and the all individual patients are properly identified in the doctor boxes 810 and the patient boxes 830. The jobs of the first-step aligners are associated with are properly specified in job boxes 820.

Once the bulk package arrives at the U.S. operator, the US operator separately reads or scans the labels on each package with the bulk package. Shipping information for the packages are extracted and packages are accordingly shipped the doctor and patients in smaller packages in the U.S.

Although specific embodiments of the present invention have been illustrated in the accompanying drawings and described in the foregoing detailed description, it will be understood that the invention is not limited to the particular embodiments described herein, but is capable of numerous rearrangements, modifications, and substitutions without departing from the scope of the invention. The following claims are intended to encompass all such modifications.

What is claimed is:

1. A system for tracking a dental device, comprising:
a label storing a data structure comprising information about a patient's dental treatment, wherein the label is configured to be attached to the dental device; and
a detector configured to extract data from the data structure stored in the label to determine the shipping destination of the dental device.

2. The system of claim 1, wherein the data structure further comprising one or more information about the doctor conducting the dental treatment, the job information for dental treatment, information about a batch of dental devices for a plurality of patients, manufacture information, and treatment schedules.

3. The system of claim 1, wherein the label includes barcodes or RFID tags.

4. The system of claim 1, wherein the label includes inductively coupled RFID tags and capacitively coupled RFID tags.

5. The system of claim 1, wherein the label is embedded inside a dental device or a package containing one or more dental device.

6. The system of claim 1, wherein the dental devices include one or more of dental aligners, dental brackets, dental arch models, tooth models, and bases or base components for tooth models.

7. The system of method 1, further comprising a computer that is configured to interpret the data extracted from the label to determine the shipping destination of the dental device.

8. A system for tracking a dental device, comprising:
a label storing a data structure comprising information about a patient's dental treatment, wherein the label is configured to be attached to the dental device;
a detector configured to extract data from the data structure stored in the label to determine the shipping destination of the dental device; and
a computer that is configured to interpret the data extracted from the label to determine the shipping destination of the dental device.

9. The system of claim 8, wherein the data structure further comprising one or more information about the doctor conducting the dental treatment, the job information for dental treatment, information about a batch of dental devices for a plurality of patients, manufacture information, and treatment schedules.

10. The system of claim 8, wherein the label includes barcodes or RFID tags.

11. The system of claim 8, wherein the label includes inductively coupled RFID tags and capacitively coupled RFID tags.

12. The system of claim 8, wherein the label is embedded inside a dental device or a package containing one or more dental device.

13. The system of claim 8, wherein the dental devices include one or more of dental aligners, dental brackets, dental arch models, tooth models, and bases or base components for tooth models.

14. The system of method 8, further comprising a computer that is configured to interpret the data extracted from the label to determine the shipping destination of the dental device.

15. A method for tracking dental devices, comprising:
setting up data structure comprising information about a patient's dental treatment;
storing the data structure in a label;
attaching the label to a dental device; and
extracting data from the data structure stored in the label to determine the shipping destination of the dental device.

16. The method of claim 15, wherein the data structure further comprising one or more information about the doctor conducting the dental treatment, the job information for dental treatment, information about a batch of dental devices for a plurality of patients, manufacture information, and treatment schedules.

17. The method of claim 15, wherein the label includes one or more of a barcode, an RFID tag, an inductively coupled RFID tag, and a capacitively coupled RFID tag.

18. The method of claim 15, wherein the label is embedded inside a dental device or a package containing one or more dental device.

19. The method of claim 15, wherein the dental devices include one or more of dental aligners, dental brackets, dental arch models, tooth models, and bases or base components for tooth models.

20. The method of claim 15, further comprising fabricating the dental component in accordance with the information in the data structure stored in the label.
